(19) United States
(12) Patent Application Publication
(10) Pub. No.: US 2026/0370464 A1
(43) Pub. Date: Nov. 19, 2026

(54) SYSTEM AND METHOD FOR A UNIVERSAL CIPHER MODULE FOR SECURE KEY ENCRYPTION AND DECRYPTION

(71) Applicant: Aviz Networks, Inc., San Jose, CA (US)

(72) Inventors: Madhu Paluru, Fremont, CA (US); Nikhil Moray, Pune (IN)

(73) Assignee: Aviz Networks, Inc., San Jose, CA (US)

(21) Appl. No.: 19/211,994

(22) Filed: May 19, 2025

(51) Int. Cl. H04L 9/08; H04L 9/06

(52) U.S. Cl. CPC H04L 9/0863; H04L 9/0631; H04L 9/0894

(57) ABSTRACT

A Universal Security Cipher Module (USCM) provides a standardized cryptographic framework within a network operating system, serving as a centralized interface for encryption, decryption, and key management. By unifying cryptographic operations across all system processes, utilities, and tools, USCM ensures consistency, interoperability, and enhanced security. It replaces fragmented encryption mechanisms with a single, cohesive solution, reducing complexity and potential vulnerabilities. The module also offers well-defined APIs, enabling seamless integration and eliminating the need for disparate cryptographic implementations. In some implementations, the device may include calling, via a processor, an encryption application programming interface (API); collecting, via the processor, a feature type, a key, and an input password; encrypting the key using the input password via the processor to create an encrypted key.

### BACKGROUND

Open-source network operating systems are increasingly coming into use with the widespread adoption of networking infrastructure. However, the need for unified encryption decryption infrastructure remains as there are currently too many different standards which causes challenges to maintaining security and data protection. As there are so many different applications and services implementing their own cryptographic methods, this creates inconsistencies which can create security vulnerabilities as well as issues with encryption and decryption.

What is needed is a centralized security cipher module which makes it possible to enforce uniform security policies.

### SUMMARY

The present disclosure presents a Universal Security Cipher Module (USCM) which is introduced as a standardized cryptographic framework within a network operating system.

The USCM module serves as a centralized interface for encryption, decryption, and key management. The UCSM module is configured to provide consistency, interoperability, and enhanced security across various applications and services. According to an embodiment, the USCM is also configured to provide well-defined APIs for encryption and decryption, eliminating the need for disparate cryptographic implementations.

According to an embodiment the UCSM module will support widely used encryption standards like AES, ensuring adherence to modern security practices and regulatory requirements.

A centralized password management can facilitate efficient handling of secure passwords, including storage and retrieval, minimizing the risk of unauthorized access. The USCM module utilizes hardware acceleration (according to an embodiment) and optimized cryptographic libraries to improve encryption and decryption speed while maintaining security.

The USCM module enforces encryption policies at the system level, ensuring that cryptographic operations align with organizational security standards. Additionally, access control mechanisms will restrict unauthorized use of encryption passwords and algorithms. By implementing a Universal Security Cipher Module, a network operating system can enhance data security, reduce vulnerabilities, improve efficiency, and ensure consistent compliance with cryptographic standards across all applications and services.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include calling, via a processor, an encryption application programming interface (API); collecting, via the processor, a feature type, a key, and an input password; encrypting the key using the input password via the processor to create an encrypted key. Other embodiments of this aspect include corresponding computer systems, apparatus, and computer programs recorded on one or more computer storage devices, each configured to perform the actions of the methods.

Implementations may include one or more of the following features: Said method where the input password is used only once. Said method where the feature type collection is mandatory. Said method where the processor validates the feature type against a stored configuration. Said method may include decoding the encrypted key and subsequently decrypting the decoded key using AES. Implementations of the described techniques may include hardware, a method or process, or a computer tangible medium.

In one general aspect, system may include A system having:. Other embodiments of this aspect include corresponding computer systems, apparatus, and computer programs recorded on one or more computer storage devices, each configured to perform the actions of the methods.

Implementations may include one or more of the following features. System where the input password is used only once. Non - transitory computer - readable medium where the feature type collection is mandatory. Implementations of the described techniques may include hardware, a method or process, or a computer tangible medium.

In one general aspect, non - transitory computer - readable medium may include 11. A non-transitory computer-readable medium storing a set of instructions, the set of instructions having:. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates an embodiment of a Universal Security Cipher module according to an embodiment of the present disclosure.

FIG. 2 details a process flow for encryption according to an embodiment of the present disclosure.

FIG. 3 details a process flow for decryption according to an embodiment of the present disclosure.

FIG. 4 is a flowchart of an example process 400.

### DETAILED DESCRIPTION

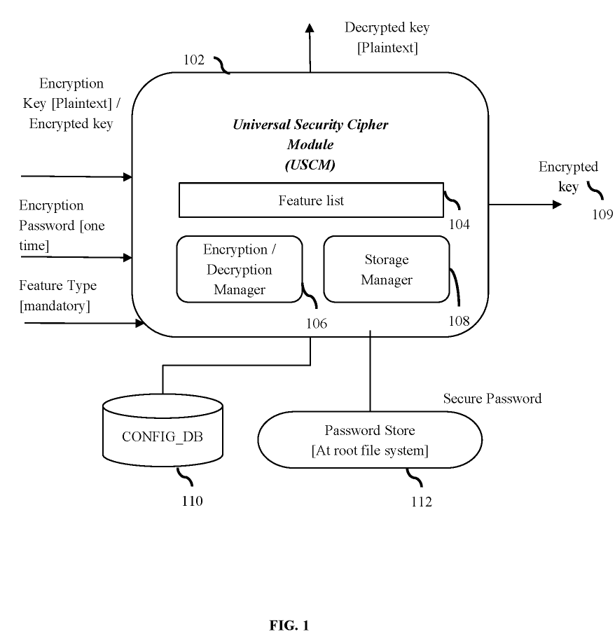

FIG. 1 illustrates an embodiment of a Universal Security Cipher module according to an embodiment of the present disclosure. UCSM 102 includes a feature list 104, an encryption/decryption manager 106, and a storage manager 108.

According to an embodiment of the present disclosure, the UCSM 102 receives three primary inputs to initiate its encryption process: an encryption key (either in plaintext or encrypted form), an encryption password (which is used only once according to an embodiment), and a mandatory feature type. According to an embodiment of the present disclosure, the key in plain text format will be encrypted by the encryption process, whereas the encrypted key will be converted into plain text with the help of the decryption process outlined below. According to an embodiment of the present disclosure, the encryption password is required only during the encryption process and during the decryption process, the encryption password will be read from the storage manager. These inputs collectively ensure secure key handling and proper configuration of the encryption mechanism. The system is designed to validate and process each input according to strict security protocols, maintaining the integrity and confidentiality of sensitive data.

UCSM 102 serves as a centralized interface for encryption, decryption, and key management. In one embodiment, UCSM 102 may comprise a dedicated microcontroller or secure processor embedded within the hardware platform (for example a SoC, motherboard, or trusted platform module) which may be specifically designed to execute cryptographic operations such as encryption, decryption, and key generation.

UCSM 102 may further comprise a hardware implemented controller that is configured to expose a standardized encryption API (such as the USCM API) to the operating system. This interface handles incoming encryption, decryption, and key management commands, ensuring standardized access while enforcing strict access controls.

It can be appreciated that configuring UCSM 102 as a standalone module provides a dedicated logic unit to efficiently encrypt and decrypt across various applications and services. According to an embodiment of the present disclosure, UCSM 102 further provides substantive APIs for encryption and decryption. Such an approach eliminates the need for disparate cryptographic implementations to promote uniform security policies and reduces redundancy.. In an embodiment, UCSM 102 can leverage hardware acceleration and optimized cryptographic libraries to significantly enhance the speed and efficiency of encryption and decryption operations while maintaining a high level of security. Where available, UCSM 102 interfaces with hardware-based cryptographic accelerators, such as Intel® AES-NI (Advanced Encryption Standard New Instructions) or ARM® Cryptography Extensions, to offload computationally intensive cryptographic functions from the main processor. This is achieved through integration with optimized cryptographic libraries, such as OpenSSL configured to detect and utilize hardware capabilities at runtime. For instance, the UCSM 102 may invoke OpenSSL's EVP (Envelope) API layer, which automatically routes AES operations through hardware-accelerated code paths when supported. In implementations where hardware acceleration is not available, UCSM 102 falls back to highly optimized software routines to ensure consistent performance. This dual-mode operation ensures that encryption, decryption, and base64 encoding tasks are executed with minimal latency while preserving the integrity and confidentiality of sensitive key material. Technically, this involves enabling the OPENSSL_ia32cap environment flags during initialization to advertise hardware features, and configuring UCSM 102 to select appropriate cipher contexts based on dynamic capability checks during module startup.

The USCM module can enforce encryption policies at the system level which ensures that cryptographic operations align with organizational security standards. Additionally, access control mechanisms restricts unauthorized use of encryption passwords and algorithms.

According to an embodiment, UCSM 102 is also connected to a CONFIG_DB 110 and a password store 112. UCSM 102 provides a decrypted key in plaintext as well as an encrypted key. The user must specify the feature type when calling the encryption interface, as well as during the key decryption. The CONFIG_DB 110 stores configuration parameters, access policies, and feature metadata associated with the encryption and decryption processes. The password store 112 securely maintains user credentials and passwords used for key derivation and authentication. During operation, UCSM 102 validates the feature type against the stored configurations to ensure proper handling and access control of the keys before performing any cryptographic operations.

The Encryption/Decryption Manager (EDM) 106 is tasked with performing the core cryptographic operations and in particular the encryption and decryption of input keys. In one embodiment, the EDM leverages the OpenSSL library to ensure industry standard security and performance.

For key encryption, the user is required to submit the key in plaintext format, along with a one-time encryption password and the relevant feature type. Upon receiving these inputs, the EDM securely encrypts the key using the provided password. Conversely, for key decryption, the user supplies the encrypted key and the corresponding feature type. The EDM then retrieves the appropriate encryption password associated with that feature type from the Storage Manager 108 and proceeds to decrypt the key.

This approach offers several benefits: it ensures that key management operations remain decoupled from user credentials, provides a secure and modular mechanism for handling sensitive data, and supports enhanced traceability and control through feature-based encryption policies. By leveraging OpenSSL, the system benefits from proven cryptographic algorithms and a high level of interoperability with other secure systems.

The SM will be responsible for securely storing the encryption passwords for each feature. When the encrypt API is called, the USCM will create an internal map between the feature type and input encryption password, and store it in the root file system of a SONiC device. Access to this file will be restricted to the root user only, protecting the encryption password from unauthorized users.

This module will also manage the removal of encryption passwords if the user decides to discontinue key encryption and revert to using the key in plaintext. This can be achieved by calling a cleanup() API. It only needs a “feature type” as an input to delete the respective encryption password.

The USCM can interface with the CONFIG_DB to allow users to enable backward compatibility for certain features. This is in addition to the EDM and SM interfaces. The USCM support can easily be extended to a new feature or an application module by simply extending the existing Feature List.

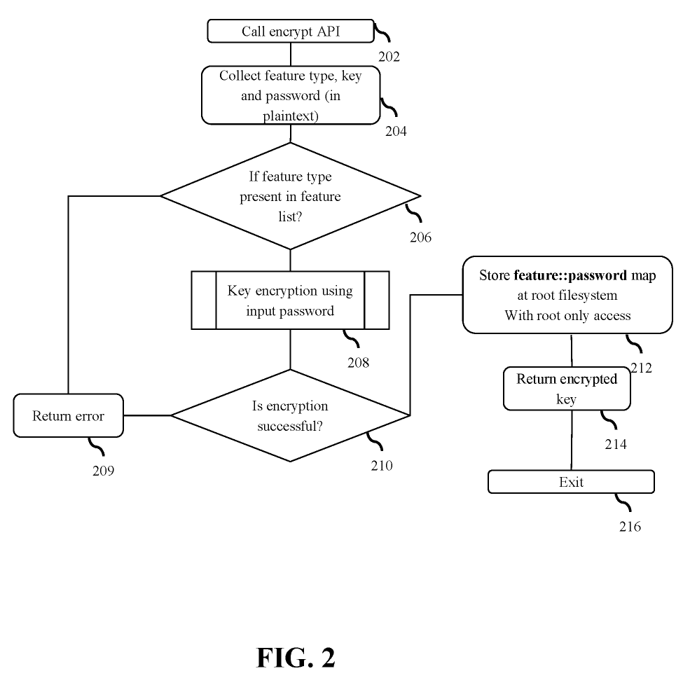

FIG. 2 details a process flow for encryption according to an embodiment of the present disclosure. At step 202, the process begins by calling the encryption API, which initiates the encryption protocol necessary for securing data transactions. This step involves loading the relevant libraries and ensuring the API is correctly authenticated. Then, at step 204, the feature type, key, and password are collected. The processor utilizes secure methods to gather these elements, verifying their integrity and ensuring they are free from tampering. These components are essential for the subsequent encryption process.

In step 206, the system checks if the feature type is present in the feature list; if it is not, an error is returned in step 209. This involves querying a securely stored database that holds valid feature types. If the feature type is present, key encryption using the input password occurs in step 208. The encryption process employs cryptographic algorithms, such as AES (Advanced Encryption Standard), to ensure robust security. Next, in step 210, the system verifies if the encryption is successful by checking the integrity of the encrypted data and confirming that it meets security standards. If the encryption is successful, the feature::password map is stored at the root filesystem with root-only access permissions in step 212. This step leverages secure file storage protocols to prevent unauthorized access. Finally, the encrypted key is returned in step 214, completing the process and ensuring the key can be securely used in future operations.

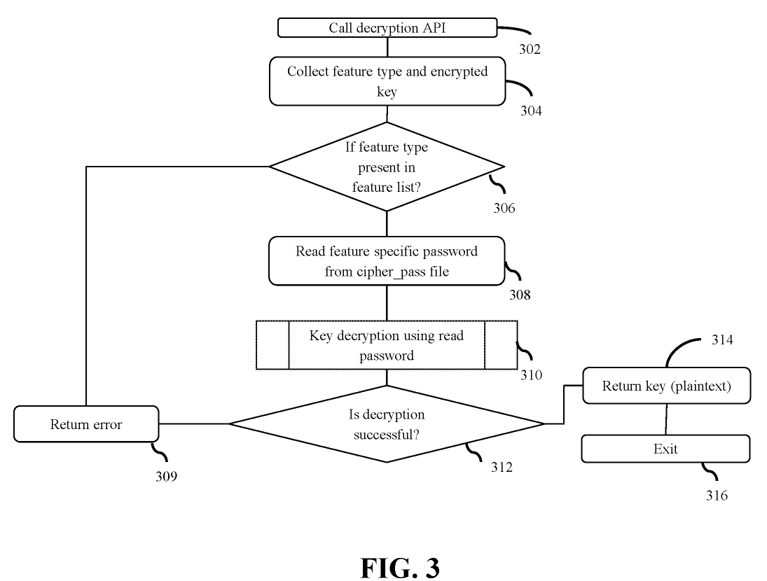

FIG. 3 details a process flow for decryption according to an embodiment of the present disclosure. At step 302, the process begins by calling the decryption API,which initiates the decryption protocol. This step involves loading the relevant libraries and ensuring the API is correctly authenticated. Then, at step 304, the feature type and encrypted key are collected. The processor utilizes secure methods to gather these elements, verifying their integrity and ensuring they are free from tampering. These components are essential for the subsequent decryption process.

In step 306, the system checks if the feature type is present in the feature list; if it is not, an error is returned in step 309. This involves querying a securely stored database that holds valid feature types. If the feature type is present then the system proceeds to ead feature specific password from cipher pass file in step 308.

Next, in step 310, the system does key decryption using the read password. Step 312 checks if decryption is successful, and if so then the key is returned in plaintext in step 314 and the system exits in step 316.

If the decryption check fails in step 312, the system proceeds to step 309 where an error is logged, and an appropriate error code is generated. This ensures that any failure in key decryption is captured for audit and troubleshooting purposes. The system may additionally trigger a limited number of retry attempts, as specified by a configured policy, before terminating the operation. If retries are exhausted or immediate termination is mandated, the system securely exits in step 316 to prevent unauthorized access attempts.

According to an embodiment, following a successful decryption in step 314, and before exiting in step 316, the decrypted plaintext key may optionally be subjected to additional integrity verification. For example, a checksum, hash comparison, or digital signature validation can be applied to ensure that the decrypted key has not been tampered with or corrupted during storage or transmission. If integrity verification fails, the system treats it as a decryption failure and proceeds through the failure handling path described above.

According to an embodiment, throughout the decryption process, UCSM 102 maintains the decrypted key within a protected memory space that is isolated from standard application memory to minimize exposure risks. Memory used to store sensitive information is immediately zeroized after use to ensure no residual key material remains accessible after the system exits or transitions between steps. Hardware security features, such as secure enclaves or Trusted Execution Environments (TEE), can be employed to further strengthen protection during this critical phase.

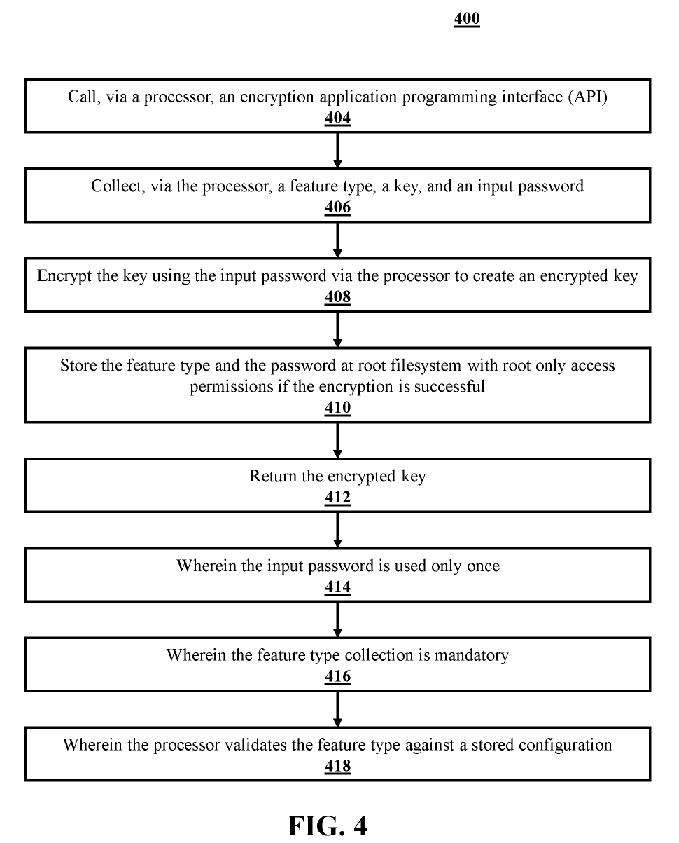

FIG. 4 is a flowchart of an example process 400. In some implementations, one or more process blocks of FIG. 4 may be performed by a USCM . Process 400 may involve invoking an encryption application programming interface (API) via a processor (block 404). For instance, the device may utilize the processor to initiate a call to the encryption API, as previously described. In one example, the processor calls an AES encryption function provided by the OpenSSL library, such as EVP_EncryptInit_ex, to initialize the encryption context with a specified key and initialization vector. This allows the system to securely encrypt an input key or data block using standardized cryptographic routines, ensuring both performance and compliance with secure coding practices.

As further shown in FIG. 4, process 400 may include collecting, via the processor, input variables (block 406). For example, USCM may collect, via the processor, a feature type, a key, and an input password, as described above. As also shown in FIG. 4, process 400 may include encrypting the key (block 408). For example, USCM may encrypt the key using the input password via the processor to create an encrypted key, as described above. As further shown in FIG. 4, process 400 may include storing the feature type and the password (block 410). For example, USCM may store the feature type and the password at root file system with root only access permissions if the encryption is successful, as described above. As also shown in FIG. 4, process 400 may include returning the encrypted key (block 412).

Process 400 may include additional implementations, such as any single implementation or any combination of implementations described below and/or in connection with one or more other processes described elsewhere herein. In a first implementation, the input password is used only once.

In a second implementation, alone or in combination with the first implementation, the feature type collection is mandatory.

In a third implementation, alone or in combination with the first and second implementation, the processor validates the feature type against a stored configuration.

A fourth implementation, alone or in combination with one or more of the first through third implementations, process 400 may include decoding the encrypted key and subsequently decrypting the decoded key using AES.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software.

It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
calling, via a processor, an encryption application programming interface (API); collecting, via the processor, a feature type, a key, and an input password; encrypting the key using the input password via the processor to create an encrypted key;
storing the feature type and the password at root filesystem with root only access permissions if the encryption is successful; and
returning the encrypted key.

2. The method of claim 1, wherein the input password is used only once.

3. The method of claim 2, wherein the feature type collection is mandatory.

4. The method of claim 3, wherein the processor validates the feature type against a stored configuration.

5. The method of claim 3, further comprising decoding the encrypted key and subsequently decrypting the decoded key using AES.

6. A system comprising:
one or more processors configured to:
call, via a processor, an encryption application programming interface (API) collect, via the processor, a feature type, a key, and an input password encrypt the key using the input password via the processor to create an encrypted key.

7. The system of claim 6, wherein the input password is used only once.

8. The system of claim 7, wherein the feature type collection is mandatory.

9. The system of claim 8, wherein the processor validates the feature type against a stored configuration.

10. The system of claim 8, wherein the one or more processors are further configured to:
decode the encrypted key and subsequently decrypting the decoded key using AES.

11. A non-transitory computer-readable medium storing a set of instructions, the set of instructions comprising:
one or more instructions that, when executed by one or more processors of a device, cause the device to:
call, via a processor, an encryption application programming interface (API)
collect, via the processor, a feature type, a key, and an input password
encrypt the key using the input password via the processor to create an encrypted key.

12. The non-transitory computer-readable medium of claim 11, wherein the input password is used only once.

13. The non-transitory computer-readable medium of claim 12, wherein the feature type collection is mandatory.

14. The non-transitory computer-readable medium of claim 13, wherein the processor validates the feature type against a stored configuration.

15. The non-transitory computer-readable medium of claim 13, wherein the one or more instructions further cause the device to:
decode the encrypted key and subsequently decrypting the decoded key using AES.
